(19) United States
(12) Patent Application Publication
(10) Pub. No.: US 2026/0125562 A1
(43) Pub. Date: May 7, 2026

(54) PARTICULATE MATTER AND USES THEREOF

(71) Applicant: U.B.Q Materials Ltd., Tel Aviv (IL)

(72) Inventors: Gil Felus, Tel Aviv (IL); Gadi Stahl, Tel Aviv (IL); Jack (Tato) Bigio, Tel Aviv (IL)

(21) Appl. No.: 19/105,252

(22) PCT Filed: Aug. 31, 2023
(86) PCT No.: PCT/IL2023/050929

§ 371 Date: Feb. 20, 2025

(30) Foreign Application Priority Data
Sep. 1, 2022 (IL) 296180

(51) Int. Cl. C09C 1/30; B82Y 30/00; C09C 1/36

(52) U.S. Cl. CPC C09C 1/3063; C09C 1/3669; B82Y 30/00; C01P 2002/82; C01P 2002/88; C01P 2004/64; C01P 2006/12

(57) ABSTRACT

The present disclosure concerns particulate matter including insoluble, non-magnetic, inorganic oxide particles, having, on each particle's surface, a plurality of, covalently grafted, ricinoleate compounds. The particulate matter is particularly suitable for odor scavenging of heterogenous materials. Further, the present disclosure provides a method of producing the particulate matter, articles of manufacture comprising the particulate matter and methods of producing the particulate matter.

### TECHNOLOGICAL FIELD

The present disclosure relates to particulate matter and uses thereof.

### BACKGROUND ART

References considered to be relevant as background to the presently disclosed subject matter are listed below:
International patent application publication No. WO2010/082202
International patent application publication No. WO12007949
International patent application publication No. WO22113068
Koran Patent Application Publication No. KR102355011
Chinese Patent Application Publication No. CN103044776
Gyergyek S, et al. Journal of colloid and interface science. 2011 Feb. 15; 354(2): pp. 498-505
Kyobe J W, et al. International Nano Letters. 2016 December; 6(4): pp. 235-42
Shombe G B, et al., Materials Science in Semiconductor Processing. (2015), vol. 43, 1 Mar. 2016, pp. 230-237
Feng B H and Zhang Z Y. Advanced Materials Research 2011, vol. 236, pp. 1783-1788
Andriayani A, et al. Advanced Materials Research, 2013, vol. 789, pp. 124-131
Kirchberg S, et al. Journal of Nanomaterials. 2012 Jan. 1; 2012
Zuliani A, et al. Journal of Colloid and Interface Science. 2022 May 15; 614: pp. 451-459.

Acknowledgement of the above references herein is not to be inferred as meaning that these are in any way relevant to the patentability of the presently disclosed subject matter.

### BACKGROUND

Plastics and recycled material emit odor and/or Volatile Organic Compounds (VOCs) such as solvents, residual monomers, plasticizers, processing aids, and reaction and decomposition products. Such emissions contribute to environmental pollution, affect ambient air quality, and hamper overall customer satisfaction, especially when the emission of malodorous VOCs is concerned.

The VOC emission may become acute in recycled post-consumer plastics, wherein the level of contamination with malodorous VOCs is particularly high.

WO2010/082202 describes a composite material having thermoplastic properties and comprising organic matter and optionally one or both of inorganic matter and plastic. Such a composite material may be prepared from waste such as domestic waste. For preparation of the composite material, waste is dried, optionally particulated. The dried and optionally particulated waste material is then heated, while mixing under shear forces. The composite material is processed to obtain useful articles.

WO12007949 describes, inter alia, a composite material comprising a first component and a second component, the first component comprising an organic element and a thermoplastic element and the second component comprising at least one element selected from the group consisting of vulcanized rubber and tire cords.

WO22113068 describes, inter alia, a composite material a homogenous blend of non-plastic organic matter, plastic matter and inorganic matter; wherein said composite material comprises aryl containing synthetic polymers in an amount of less than 10% percent out of the total weight of the composite material; and wherein said composite material is characterized by physical properties.

KR102355011 relates to a method of electrochemically producing zinc ricinoleate particles using anodic oxidation.

CN 103044776 describes a low-smell homo-polypropylene composition comprising inter alia a mineral filler (e.g., barium sulfate), antioxidants, a deodorization agent (e.g., ricinoleic acid zinc salt).

Gyergyek S, et al. describe a colloidal stability of oleic and ricinoleic acid coated magnetic nanoparticles in organic solvents.

Kyobe J W, et al. describe the use of castor oil and ricinoleic acid in lead chalcogenide nanocrystal synthesis.

Shombe G B, et al., describe synthesis and characterization of castor oil and ricinoleic acid capped CdS nanoparticles.

Feng B I and Zhang Z Y., describe a chitosan derivate prepared by grafting ricinoleic acid anhydride on carboxymethyl chitosan (CMC) molecules for use as nanopesticide carrier.

Andriayani A, et al. describe synthesis of mesoporous silica from tetraethylorthosilicate by using sodium ricinoleic as a template and 3-aminopropyltrimethoxysilane.

Kirchberg S, et al. describe nanocomposites based on technical polymers and sterically functionalized soft magnetic magnetite nanoparticles.

Zuliani A et al., describe zinc oxide (ZnO)/Castor oil polyurethane composites for the gas phase adsorption of acetic acid.

### GENERAL DESCRIPTION

The present disclosure is based on the finding that when ricinoleic acid compounds are directly linked to insoluble inorganic particles, the resulting particulate matter is efficient in reducing odor and/or volatiles emission from recycled waste, when the particulate matter is blended within recycled matter.

Thus, in accordance with a first aspect of the presently disclosed subject matter, there is provided particulate matter comprising insoluble, non-magnetic, inorganic oxide particles, having, on each particle's surface, a plurality of, covalently grafted, ricinoleate compounds.

In accordance with a second aspect of the presently disclosed subject matter there is provided a method of producing particulate matter, the method comprising:
i) providing a suspension comprising insoluble inorganic oxide particles and a source of ricinoleate compounds; and
ii) subjecting said suspension to at least a sonication process.

In accordance with a third aspect of the presently disclosed subject matter there is provided an article of manufacture comprising a homogenous blend of (i) particulate matter comprising insoluble, non-magnetic, inorganic oxide particles, having, on each particle's surface, a plurality of, covalently grafted, ricinoleate compounds, and (ii) at least one thermoplastic material.

In accordance with a fourth aspect of the presently disclosed subject matter, there is provided a method of producing an article of manufacture. In some aspects, the method comprises processing a blend of (i) particulate matter comprising insoluble, non-magnetic, inorganic oxide particles, having, on each particle's surface, a plurality of, covalently grafted, ricinoleate compounds and (ii) thermoplastic material, said processing comprises at least one of extrusion, molding, injection molding, compression molding or blown film of said blend.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 is a graph showing Attenuated Total Reflection—Fourier-Transform Infra Red (ATR-FTIR) spectra of silica (SiO₂), epoxidized soybean oil (ESBO), castor oil and ricinoleate-grafted silica particles (KRS-23) according to some examples of the present disclosure.

FIG. 2 is a graph showing FTIR-ATR spectra of titania (TiO₂), epoxidized soybean oil (ESBO), castor oil and ricinoleate-grafted titania particles (KRS-29) according to some examples of the present disclosure.

FIG. 3 is a graph showing FTIR-ATR spectra Zn-ricinoleate and castor oil according to some examples of the present disclosure.

FIG. 4 is a graph showing Thermogravimetric Analysis (TGA) plot, illustrating the change in sample weight as a function of temperature, of ESBO, castor oil and ricinoleate-grafted silica particles (KRS-23) according to some examples of the present disclosure.

FIG. 5 is a graph showing Derivative Thermogravimetric Analysis (DTG) plot, illustrating the rate of change of sample weight with respect to temperature, of ESBO, castor oil and ricinoleate-grafted silica particles (KRS-23) according to some examples of the present disclosure.

### DETAILED DESCRIPTION

The presently disclosed subject matter is based on the development of particulate matter that is suitable for introduction into processed plastic and/or processed waste and for preventing or at least significantly reducing unpleasant odor and/or volatiles released from the processed plastic and/or processed waste (which is present in the absence of said particulate matter). The presently disclosed particulate matter are generally comprised of insoluble particles that are stably associated, at least at their outer surface, with ricinoleate.

As will be further described hereinbelow, it was unexpectedly found that the incorporation of the particulate matter, having a size in the nanometer and/or micrometric ranges into the processed waste not only reduced significantly the odor of the processed waste, but also did not derogate the physical properties of products (article of manufacture) produced from the processes waste (as compared to the same products produced without the particulate matter).

Thus, the presently disclosed subject matter provides, in accordance with a first of its aspects, particulate matter comprising insoluble, non-magnetic, inorganic oxide particles, each particle being directly associated, i.e. covalently grafted, at least on the particle's surface, with a plurality of ricinoleate compounds.

In the context of present disclosure, when referring to “particulate matter” or “particulates” is to be understood to encompass localized physical objects that can be ascribed certain physical or chemical properties such as volume, size, density, mass, chemical composition, surface chemistry, etc., and contain at least the insoluble particles associated with the ricinoleate compounds.

In the context of the present disclosure, when referring to “insoluble particles” it is to be understood that the particles remain essentially intact i.e., as solid/physical objects when brought into contact with water and/or oil.

In some examples, the particles are water immiscible/insoluble.

In some examples, the particles are oil immiscible/insoluble.

In the context of the presently disclosed subject matter, when referring to “non-magnetic” or “magnetically insusceptible” is to be understood to refer to a substance or element that exhibits no, negligible or minimal magnetic susceptibility, displaying little to no attraction or interaction with magnetic fields.

The term “non-magnetic” as used herein specifically excludes particles which are selected from the group consisting of Iron Oxide (Fe₃O₄ and Fe₂O₃). Cobalt Ferrite (CoFe₂O₄), Nickel Ferrite (NiFe₂O₄), Barium Ferrite (BaFe₁₂O₁₉), Samarium Cobalt (SmCo₅ and Sm₂Co₁₇), Neodymium Iron Boron (Nd₂Fe₁₄B), Alnico (Aluminum-Nickel-Cobalt), Ferrite Ceramic, and mixtures thereof.

In the context of the presently disclosed subject matter, when referring to “inorganic oxide particles” it is to be understood to encompass particles composed of inorganic compound or aggregate containing oxygen along with one or more metallic or non-metallic elements. Such particles can be characterized by their structure, morphology, porosity, solid nature etc., and in the context of the presently disclosed subject matter, they do not exhibit magnetic properties.

In addition or alternatively, in the context of presently disclosed subject matter, when referring to “inorganic oxide particles” is to be understood to encompass particles that do not contain, as their primary component, carbon-carbon (C—C) bonds. Thus, in the context of the presently disclosed subject matter, the inorganic oxide particles exclude non-synthetic organic polymers, such as chitosan, polysaccharides or other cellulose based polymers.

In addition or alternatively, in the context of presently disclosed subject matter the term “inorganic oxide particles” specifically excludes particles which are selected from the group consisting of carbon nanotubes, graphene, activated carbon, carbon black and mixtures thereof.

In the context of the presently disclosed subject matter, the ricinoleate compounds covalently grafted onto at least the surface of the insoluble inorganic oxide particles.

When referring to covalent grafting, it is to be understood, in the context of the presently disclosed subject matter, that the ricinoleate compounds are directly chemically attached/associated, via a covalent bond, to the surface of insoluble particles.

In the context of presently disclosed subject matter, the term “directly associated” or “directly covalently grafted” is to be understood as referring to the ricinoleate compounds being in direct covalent bond and immediate proximity with the surface of individual particle.

Thus, when referring to directly covalently grafted or in brief to covalently grafted it is to be understood to include a covalent bond that is characterized by the absence of intermediary linkers, bonding agents or intervening substances between the inorganic particle's surface and the ricinoleate compound.

Further, in some examples of the presently disclosed subject matter, when referring to “covalently grafted” it is to be understood that the ricinoleate compounds are retained associated to the particle, when the particulate matter is subjected to washing with an aqueous medium (e.g., water) and/or with an organic solvent (e.g. ethanol).

Without being limited thereto, it is postulated that a covalent bond can be formed due to ester condensation between hydroxyl groups (or similar externally exposed polar groups) on the particle and carboxylic group of the ricinoleate compound. For example, when the particle comprises silica, the covalent bond can be one created between silanol groups of the silica-based particles and the carboxylic group of the ricinoleate compounds.

The presence of a chemical bond between the ricinoleate and the insoluble particles can be assessed by methods known in the art, such as FTIR or NMR following an extraction treatment (solid phase). In principle, the “loaded” particles are washed with an organic solvent such as ethanol, toluene, hexane etc., to remove any unbound material. The washed particles are then dried, filtered, and analyzed by FTIR or NMR.

The presence of a chemical bond between the ricinoleate and the insoluble particles can also be assessed by thermochemical methods known in the art, such as thermogravimetric analysis (TGA) or differential thermogravimetry (DTG).

In some examples, the presence of the chemical bond between the ricinolate and the insoluble particles is exhibited by a DTG transition peak at between 500° C. and 600° C., or at between about 540° C. and 570° C.; or at between about 550° C. and about 570° C., or at about 565° C., such a peak representing thermal decomposition of covalently bound ricinoleate.

Overall, the outcome of thermochemical characterization aligns with ATR-FTIR measurements, serving as further evidence supporting the formation of a covalent bond between ricinoleate species and particle surface.

In some examples of the presently disclosed subject matter, the presence of a chemical bond between the ricinoleate and the insoluble particles is assessed as described in Suckeveriene, R. Y., et al. “Grafting of polymer chains onto nano-silica particles via peroxide bulk polymerization.” J. Nanostructured. Polym. Nanocomposites 3 (2007): 13-21, or in Suckeveriene, R. Y., et al. “Grafting of polystyrene chains on surfaces of nanosilica particles via peroxide bulk polymerization.” Polymer composites 30.4 (2009): 422-428, the content of which is incorporated herein by reference.

In some examples of the presently disclosed subject matter, the particulate matter is characterized by its ATR-FTIR as described in Suckeveriene, R. Y., et al., to be at least at wavenumber within the range of 800 and 1100 cm⁻¹. The presence of this peak is indicative of the direct covalent bond between the ricinoleate compounds and the insoluble particle.

In the context of present disclosure, the particulate matter can comprise particles of various average sizes. Yet, all being within the nanometric and micrometric ranges. Without being bound by theory, the size of the particulate matter will be dictated by the size of the inorganic oxide particle used in its process of preparation. In other words, it is assumed that the covalent grafting of the plurality of ricinolate compounds onto at least the surface of the individual inorganic oxide carrier particles does not significantly affect the dimensions of the resulting particulate matter.

In some examples of the presently disclosed subject matter, the particles, and as such, the particulate matter have an average size (as determined along their longest cross-sectional dimension) that is less than 500 micron; at times, less than 250 micron; at times, less than 200 micron; at times, less than 150 micron; at times, less than 100 micron; at times, less than 50 micron; at times, less than 1 micron.

In some examples of the presently disclosed subject matter, the particles, and as such, the particulate matter have an average size (as determined along their longest cross-sectional dimension) that is at least 1 nm; at times, at least 5 nm; at times, at least 10 nm; at times, at least 25 nm; at times, at least 50 nm; at times, at least 100 nm; at times, at least 250 nm.

In some examples of the presently disclosed subject matter, the particles, and as such, the particulate matter have an average size within a range of between about 1 nm and about 1,000 nm.

In some examples of the presently disclosed subject matter, the particles, and as such, the particulate matter have an average size of between about 1 nm and about 800 nm; at times, between about 1 nm and about 600 nm; at times, between about 1 nm and about 400 nm; at times, between about 1 nm and about 200 nm, at times, between about 1 nm and about 100 nm; at times, between about 1 nm and about 50 nm; at times, between about 5 nm and about 25 nm; at times between about 5 nm and about 50 nm; at times, between about 50 nm and about 30 nm; at times, between about 1 nm and about 25 nm; at times, between about 1 nm and about 50 nm.

Generally, as appreciated by those versed in the art, particles' average size can be measured by a variety of techniques. Nanometric particle sizes can be measured at least by one of dynamic light scattering (DLS), scanning electron microscopy (SEM) or transmittance electron microscopy (TEM). Submicron and micron-sized particle sizes can be measured by at least one of sieving, photo analysis, laser diffraction or sedimentation.

In some examples of the presently disclosed subject matter, the particulate matter can be defined by the particles' specific surface areas. At times, the particulate matter comprises particles having a surface area of at least about 50 m²/g; at times, between about 50 m²/g and about 800 m²/g; at times, between about 50 m²/g and about 500 m²/g; at times, between about 100 m²/g and about 400 m²/g.

In some examples of the presently disclosed subject matter, the particles are porous particles.

In some examples of the presently disclosed subject matter, the inorganic oxide particles are selected from the group consisting of silica (SiO₂), zeolite, titania (TiO₂), alumina (Al₂O₃), clay, and mixtures thereof.

In some examples of the presently disclosed subject matter, the inorganic oxide particles are or comprise silica.

In some examples of the presently disclosed subject matter, the inorganic oxide particles are or comprise titania.

In some examples of the presently disclosed subject matter, the inorganic oxide particles are or comprise zeolite.

In some examples of the presently disclosed subject matter, the zeolite is described by a formula Mⁿ⁺_{1/n}(AlO₂)⁻(SiO₂)ₓ·yH₂O wherein M is a cation with ionic charge n.

In some examples of the presently disclosed subject matter, the inorganic oxide particles are or comprise alumina.

In some examples of the presently disclosed subject matter, the inorganic oxide particles are or comprise clay.

As described hereinbelow, the particulate matter of present disclosure is useful for a for scavenging odorous compounds and, in particular, in recycled waste. As it is readily appreciated by a person skilled in waste recycling, including plastic waste recycling or municipal waste recycling, numerous odorous compounds are chemically reactive or corrosive substances. Hence, in some examples of the presently disclosed subject matter the inorganic oxide particles can resist reactions with external factors such as heat, moisture, and reactive substances, thereby essentially preserving their original characteristics and functionality in odor scavenging.

In some examples of the presently disclosed subject matter, the inorganic oxide particles are resistant to corrosion, e.g. acidic corrosion. As such, these particles are referred to as “corrosion resistant” inorganic oxide particles.

In some examples of the presently disclosed subject matter, the particles are resistant to corrosion with acids selected from the group consisting of acetic acid, formic acid, hydrochloric acid, sulfuric acid, nitric acid and mixtures thereof. Corrosion resistance can be determined by subjecting the particulate matter or the inorganic particles forming part of the particulate matter, to IM solution of acid (e.g. acetic acid, HCl) solution for a duration of at least 30 minutes, whereby the inorganic oxide particles demonstrate no statistically significant weight loss.

In some examples of the presently disclosed subject matter, the inorganic oxide particles are substantially free of chemical elements selected from the group consisting of lead (Pb), cadmium (Cd), selenium (Se), tellurium (Te), arsenic (As) and combinations thereof.

The insoluble oxide particles carry, via covalent bonding, a plurality of ricinoleate compounds.

In the context of present disclosure when referring to “ricinoleate” or “ricinoleate compounds” it is to be understood to encompass any composition (e.g. castor oil, as further described below) or compound containing ricinoleic acid, this including also any isomers, salts, or chemical derivatives thereof.

In some examples of the presently disclosed subject matter, ricinoleate compounds are selected from the group consisting of ricinoleic acid (Formula I below), ricinolein (Formula II below), and mixtures thereof.

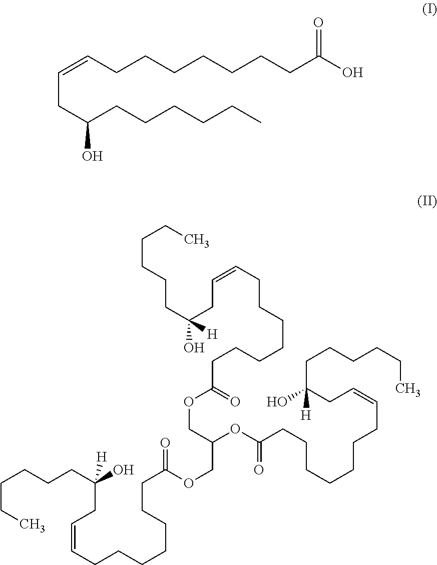 [SMILES: CCCCCC[C@@H](O)C/C=C\CCCCCCCC(=O)O ; CCCCCC[C@@H](O)C/C=C\CCCCCCCC(=O)OCC(COC(=O)CCCCCCC/C=C\C[C@H](O)CCCCCC)OC(=O)CCCCCCC/C=C\C[C@H](O)CCCCCC]

In some examples of the presently disclosed subject matter, the ricinoleate compound is ricinoleic acid.

In some examples of the presently disclosed subject matter, the ricinoleate compound is ricinolein.

The particulate matter according to presently disclosed subject matter can be in a variety of physical forms.

In some examples of the presently disclosed subject matter, the particulate matter is in a dry powder form.

In some examples of the presently disclosed subject matter, the particulate matter is in a form of a dispersion within a liquid carrier.

In some examples of the presently disclosed subject matter, the liquid carrier is an organic liquid carrier.

In some examples, the organic liquid carrier comprises an oil.

In some examples of the presently disclosed subject matter, the particulate matter is dispersed in an oil selected from the group consisting of epoxidized soybean oil (ESBO), tall oil, castor oil, linseed oil, palm oil, etc.

In some examples of the presently disclosed subject matter, the particulate matter is dispersed in ESBO.

The particulate matter can have different applications.

The presently disclosed particulate material is suitable for scavenging volatiles and/or odors.

In the context of present disclosure, when referring to “scavenger” or “scavenging” it is to be understood to encompass materials or processes which are capable of capturing certain chemical compounds, statistically reducing presence of such compounds in a surrounding environment. In the context of present disclosure, the term “scavenger” or “scavenging” is ascribed with the property of the presently disclosed particulate matter to capture odors and/or volatiles (e.g., VOC) from at least recycled/processed waste and/or recycled/processed plastic, as further described below.

In the context of the presently disclosed subject matter, it is to be understood that the scavenging property of the particulate matter does not intend to mean that all traces of the certain chemical compounds to be captured are eliminated.

In some examples of the presently disclosed subject matter, the particulate matter presently disclosed is intended to/suitable for capturing one or more volatile compounds.

In the context of presently disclosed subject matter, when referring to “a volatile compound” or “volatile” it is to be understood to encompass chemical compounds with at least some level, preferably high vapor pressure at room temperature.

A capacity of the presently disclosed particulate matter to scavenge volatile compounds can be determined by any one of gas chromatography (GC) analysis, gas chromatography analysis with flame ionization detector (GC-FID), or gas chromatography coupled with mass spectrometry (GC-MS) analysis, or even using a smelling panel.

In some examples of the presently disclosed subject matter, the particulate matter is being suitable for scavenging odorous compounds.

In the context of presently disclosed subject matter, when referring to “odorous compounds” or “odors” it is to be understood to encompass chemical compounds that humans or other animals perceive via the sense of smell or olfaction.

A capacity of the presently disclosed particulate matter to scavenge odorous compounds can be demonstrated by sensory test.

As appreciated, while some overlap exists, not all volatiles are odorous and vice versa.

Scavenging properties of the presently disclosed particulate matter were exhibited by blending the particulate matter with odor-releasing waste derived material. The blended material was then processed into a molded specimen. The specimens were then submitted to a sensory test by trained smelling panel. Odor intensity of the specimens was graded between 0 and 5 compared to a reference sample (a specimen of the same type, yet, produced without the particulate matter).

In some examples of the presently disclosed subject matter, the odor-releasing material is a composite material as described in any one of WO22/113068, WO2010/082202 and WO23/031911 the content of which is incorporated herein by reference.

The composite material of any one of WO22/113068, WO2010/082202 and WO23/031911, and WO2012/007949 exhibited properties, including physical properties that allow the composite material to be used in the thermoplastic industry, e.g. as a virgin or recycled plastic replacement. Thus, such a composite material is encompassed herein by the term “thermoplastic material” due to its thermoplastic properties, as further discussed below.

The homogenous blending of the presently disclosed particulate matter with the heterogenous-waste derived composite material (“thermoplastic material”) allows not only the reduction of plastic usage or of recycled plastic, but also providing products/articles of manufacture, that are odorless as compared to the same products obtained without the presently disclosed particulate matter.

The presently disclosed subject matter also relates, in accordance with a second of its aspects, to a method of producing the particulate matter of the presently disclosed first aspect, the method comprising:
providing a suspension comprising insoluble inorganic oxide particles (as defined hereinabove and below) and a source of ricinoleate compounds;
subjecting said suspension to at least a sonication process; and
optionally separating the particulate matter.

The presently disclosed method provides, inter alia, the presently disclosed particulate matter. Thus, for the sake of simplicity, all terms and definitions provided in connection with the particulate matter also apply to the presently disclosed method of producing the particulate matter, mutatis mutandis.

According to the presently disclosed method, the insoluble inorganic oxide particles, as defined herein with respect to the particulate matter, are firstly mixed with a source of ricinoleate compounds, the ricinoleate compounds being as defined hereinabove. The source of ricinoleate compounds can be, for example, ricinoleate per se or castor oil, known to contain ricinoleate. In this connection, it is to be noted that when referring to castor oil it is to be understood to also encompass derivatives thereof, e.g., containing different concentration of ricinoleate (at times defined as the castor oil grade). Thus, castor oil, in the context of the presently disclosed subject matter includes the oil in any grade/ricinoleate concentration.

The mixture of the insoluble inorganic oxide particles and the source of ricinoleate compounds are suspended within a medium.

In some examples of the presently disclosed subject matter, the particles and source of ricinoleate compounds are suspended in an organic medium.

In some examples of the presently disclosed subject matter, the organic medium comprises or is an oil.

In some examples of the presently disclosed subject matter, the oil is selected from the group consisting of epoxidized soybean oil (ESBO), tall oil, castor oil, linseed oil and palm oil.

In some examples of the presently disclosed subject matter, the particles and the source of ricinoleate compounds are suspended in an oil medium that comprises at least ESBO.

The concentration of the insoluble inorganic oxide particles and/or of the source of ricinoleate compounds in the suspension may vary. Yet, in some examples, the concentration of insoluble inorganic oxide particles in the suspension is within a range of about 5 g/L and about 100 g/L, at times between about 5 g/L and about 0 g/L, at times between about 8 g/L and about 20 g/L, at times between about 18 g/L and about 40 g/L, at times between about 38 g/L and about 60 g/L, at times between about 55 g/L and about 80 g/L, at times between about 75 g/L and about 100 g/L.

Further, in some examples, the concentration of the source of ricinoleate compounds in the suspension is within a range of about 1 g/L and about 200 g/L, at times between about 1 g/L and about 5 g/L, at times between about 3 g/L and about 10 g/L, at times between about 8 g/L and about 20 g/L, at times between about 18 g/L and about 50 g/L, at times between about 40 g/L and about 90 g/L, at times between about 80 g/L and about 120 g/L, at times between about 110 g/L and about 200 g/L.

The suspension may include additional ingredients that may facilitate/promote the covalent association between the ricinoleate compounds and the insoluble particles. While not wishing to be bound by theory, it is believed that addition of free radical initiator may play a role in the chemical process that facilitates the association between the ricinoleic compounds and the insoluble particles.

In some examples of the presently disclosed subject matter, the free radical initiator can be selected from the group consisting of benzoyl peroxide, di-tert-butyl peroxide, methyl ethyl ketone peroxide and ammonium persulfate.

In some examples of the presently disclosed subject matter, the free radical initiator employed in the herein disclosed method comprises or is benzoyl peroxide.

In some examples of the presently disclosed subject matter, the benzoyl peroxide is recrystallized. Recrystallization can take place according to recrystallization procedures known to those versed in organic chemistry.

In some examples of the presently disclosed subject matter, benzoyl peroxide is used without recrystallization.

In some examples, the concentration of benzoyl peroxide in the suspension is within a range of about 0.01 g/L and about 5 g/L, at times between about 0.01 g/L and about 0.1 g/L, at times between about 0.1 g/L and about 1 g/L, at times between about 1 g/L and about 5 g/L.

In some examples of the presently disclosed subject matter, the concentration of benzoyl peroxide is about 0.05 g/L.

The suspension undergoes at least a sonication process. Without being bound thereto, the sonication causes high disruption that leads to the covalent grafting of the ricinoleate compounds onto at least the surface of the particles.

In some examples of the presently disclosed subject matter, the sonication involves at least ultrasonication (e.g. in an ultrasonic homogenizer).

It is appreciated by those versed in the art of sonochemistry, that ultrasonication may be characterized by at least one of ultrasonic power or ultrasonic frequency.

The duration and conditions of the ultrasonication can vary depending on the type of particles, source of ricinoleate, desired result, etc.

In some examples of the presently disclosed subject matter, the ultrasonic power is within a range of about 400 W and about 25 kW, at times within a range of about 400 W and about 1 kW, at times within a range of about 1 kW and about 5 kW, at times within a range of about 4 kW and about 10 kW, at times within a range of about 8 kW and about 15 kW, at times within a range of about 11 kW and about 20 kW, at times within a range of about 17 kW and about 25 kW.

In some examples of the presently disclosed subject matter, the ultrasonic frequency is within a range of about 15 kHz and about 200 kHz, at times within a range of about 15 kHz and about 25 kHz, at times within a range of about 20 kHz and about 40 kHz, at times within a range of about 35 kHz and about 50 kHz, at times within a range of about 40 kHz and about 100 kHz, at times within a range of about 80 kHz and about 120 kHz, at times within a range of about 100 kHz and about 160 kHz, at times within a range of about 150 kHz and about 200 kHz.

In some examples of the presently disclosed subject matter, the ultrasonication is maintained for from about 5 minutes and about 200 minutes, at times for from about 5 minutes and about 30 minutes, at times for from about 25 minutes and about 60 minutes, at times for from about 50 minutes and about 120 minutes, at times for from about 100 minutes and about 180 minutes, at times for from about 160 minutes and about 200 minutes.

Following at least sonication, the presently disclosed particulate matter is formed. These can then be used as is, i.e. within the suspension medium in which they were formed, or they can be subjected to one or more further processing steps, such as separation and/or purification steps.

Thus, in some examples of the presently disclosed subject matter, the particulate matter is subjected to at least one separation step, namely, the method comprises at least one separation step, to thereby isolate the ricinoleate grafted particles from the organic medium in which they were formed.

Separation can be conducted using any one of centrifugation, filtration, sedimentation and combinations thereof.

In some examples of the presently disclosed subject matter, the particulate matter is separated by centrifugation.

In some examples of the presently disclosed subject matter, the particulate matter is separated by filtration.

In some examples of the presently disclosed subject matter, the particulate matter is separated by sedimentation.

As noted above, the particulate matter disclosed herein can be used as an additive in various industries.

For example, the particulate matter can be used as an additive in the recycling business.

In some other examples, the particulate matter can be used as an additive in the waste management business.

In some examples of the presently disclosed subject matter, the particulate matter can be a priori formed into a masterbatch. In the context of the presently disclosed subject matter, the masterbatch would be a homogenous blend of (i) particulate matter comprising insoluble inorganic oxide particles, having, on each particle's surface, a plurality of, covalently grafted, ricinoleate compounds; and (ii) thermoplastic material. Yet, it was unexpectedly found that there is no need to a priori blend the particulate matter in a thermoplastic carrier material and that, in fact, the particulate matter can be used, as is, in processes commonly used in the plastic industry, such as extrusion, injection molding, compression molding or other processes that involve for homogenous mixing.

In line with the above, the particulate matter can be used, as is, or as part of the herein disclosed masterbatch, for the production of different articles of manufacture.

In some examples of the presently disclosed subject matter, the particulate matter is blended with at least one thermoplastic material, e.g. to produce such articles or a masterbatch to be used in the production of such articles. The thermoplastic material can include a single synthetic polymer, a combination of synthetic polymers, as well as a thermoplastic combination of components.

Thus, in accordance with yet another aspect of the presently disclosed subject matter, there is provided an article of manufacture that comprise the particulate matter and thermoplastic material.

The article of manufacture can be obtained by any technique known, e.g. in the plastic industry. For example, and without being limited thereto, the particulate matter can be incorporated into one or more of the processing techniques including extrusion, molding (injection molding, compression molding, extrusion, blown film), whereby such processing provides homogenous blending of the particulate matter with at least one thermoplastic material.

As noted above, it has been unexpectedly found that it is possible to homogeneously blend the presently disclosed particulate matter with a variety of thermoplastic or pseudo-thermoplastic materials, including heterogenous waste having thermoplastic behavior. The meaning of “thermoplastic behavior” should be understood to those versed in the art to refers to the capacity of the material to be reshaped, reformed, and/or recycled due to the thermoplastic nature of its composition. The material is typically which softens upon heating and solidifies upon cooling without undergoing irreversible chemical changes. In some examples of the presently disclosed subject matter, the thermoplastic material comprises one or more synthetic polymers. Accordingly, the particulate matter is blended with one or more synthetic polymers.

In some examples of the presently disclosed subject matter, the one or more synthetic polymers comprises at least one thermoplastic polymer, i.e. it may comprise also non-thermoplastic material as long as the overall combination of materials exhibits a thermoplastic behavior.

In some examples of the presently disclosed subject matter, the particulate matter is blended with at least thermoplastic virgin plastic.

In some examples of the presently disclosed subject matter, the synthetic polymer comprises at least one polyolefin (e.g., polypropylene (PP), polyethylene (PE, including high density PE, low density PE) etc.

In some examples of the presently disclosed subject matter, the synthetic polymer comprise a polymer selected from the group consisting of Acrylic, Acrylonitrile butadiene styrene (ABS), Polyamide, Polylactic acid (PLA), Polybenzimidazole, Polycarbonate, Polyether sulfone, Polyoxymethylene, Polyether ether ketone, Polyetherimide, Polyethylene, Polyphenylene oxide, Polyphenylene sulfide, Polypropylene, Polystyrene, Polyvinyl chloride, Polyvinylidene fluoride, Polytetrafluoroethylene (Teflon) and combinations thereof.

In some examples of the presently disclosed subject matter, the thermoplastic material is a polymer mixture comprising a heterogenous combination of synthetic polymer (plastics). In some examples, the polymer mixture comprises heterogenous plastic waste (including at times also some amount of thermoset polymers).

In some examples of the presently disclosed subject matter, the thermoplastic material is a combination of a heterogenous mixture of plastics and heterogenous mixture of non-synthetic organics, optionally including also inorganic matter.

In some examples of the presently disclosed subject matter, the thermoplastic material is a composite material of a type disclosed in WO2010/082202, the content of which is incorporated herein by reference. In general, the thermoplastic material disclosed in WO2010/082202 comprises organic matter, synthetic polymers (plastics) and optionally inorganic matter, the amount of synthetic polymers being up to 40 wt %, and the amount of organic matter ranging between 10 wt % and 90 wt %, and optionally inorganic matter.

In some further examples of the presently disclosed subject matter, the thermoplastic material is a composite material of a type disclosed in WO2012/007949, the content of which is incorporated herein by reference. In general, the thermoplastic material disclosed in WO2012/007949 is comprised of at least two components, a first component comprising an organic element and a thermoplastic element (e.g., the composition disclosed in WO2010/082202) and a second component comprising at least one element selected from the group consisting of vulcanized rubber and tire cords. The amount of the first component is between about 10 wt % to about 50 wt % of the total weight of the composite material and the amount of the second component is between 50 wt % to about 90 wt % out of the total amount of this type of composite material.

In some further examples of the presently disclosed subject matter, the thermoplastic material is a composite material of a type disclosed in WO2022/113068, the content of which is incorporated herein by reference. In general, the thermoplastic material disclosed in WO2022/11.3068 is comprised of a homogenous blend of: at least about 40 wt % of non-plastic organic matter out of a total weight of the composite material, the non-plastic organic matter comprising at least cellulose; and between about 5 wt % and about 50 wt % plastic (synthetic polymer) matter out of a total weight of said composite material, the plastic matter comprising a plurality of synthetic thermoplastic polymers; and up to 15 wt % inorganic matter. The composite material of this type comprises between 0 wt % and 5 wt % polyethylene teraphthalate (PET).

In some further examples of the presently disclosed subject matter, the thermoplastic material is a composite material of a type disclosed in WO23/031911, the content of which is incorporated herein by reference. In general, the thermoplastic material disclosed in WO23/031911 comprises up to 90 wt % heterogenous organic matter, and typically not more than 3 wt % synthetic plastics.

Thus, in some examples of the presently disclosed subject matter, the thermoplastic material being mixed with the particulate matter and from which odor scavenging is required is or comprises the composite material described in any one of WO22/113068, WO2010/082202, WO2012/007949 and WO23/031911. The composite material of any one of WO22/113068, WO2010/082202 and WO23/031911 is obtained by drying and particulating the substantially unsorted heterogenous waste and heating while mixing the dried waste to a temperature in which the material softens, under shear forces (e.g. extrusion) to form the composite material (referred to herein as the thermoplastic material).

At times, the substantially unsorted heterogenous waste from which the thermoplastic material is obtained, is subjected to at least one separation step that comprises removal of incompatible plastics, including at least aryl-containing synthetic polymers from said particulate heterogenous waste, the separation being based on Near Infra-Red (NIR) absorbance, to obtain a heterogenous intake material; and subjecting the heterogenous intake material to at least one processing under shear forces, e.g. extrusion, at a temperature maintained within a range of 150° C. and 200° C. The resulting material is then preferably subjected to one or more downsizing processes to obtain the composite material in powder form, typically with an average size of below 1 nm (preferably 1 μm-1 mm), as further discussed below.

In some examples of the presently disclosed subject matter, the composite material discharged from the extruder (or other form of processor under shear forces) is subjected to at least one refinement stage that involves size reduction. This refinement is typically after the discharged composite material is cooled.

In some examples, the refinement involves milling of the composite material using any conventional milling system.

In some examples, the milling involves passing the composite material through a continuous milling process, such as a Hammer Mill (e.g. type 40/32 HA). In some other examples, the extrudate is subjected to an Impact milling process, where high speed rotating blades (beater plates) smash the composite material against the enclosing walls and against itself, and the friction causes reduction in size.

In some examples, refinement can be achieved by subjecting the composite material to “Knife Mil” such as that achieved by using ROTOPLEX 50\100. The technology is designed to make high cutting forces with a high throughput. Using the principle of “scissors” a drum with knives moves at high speed in front of a counter knife in a cooled environment.

In some examples, refinement is done by a combination of two or more refinement techniques, e.g. a first making use of hammer mill technology and the second making use of impact milling technology. The combination of technologies allows for the reduction of the powder sider below 1.5 mm.

In some examples, the extrudate was subject to size reduction using a combination of milling devices set to grind the extrudate into powder (refined composite material), and by sieving through the desired sieves, e.g. 500 μm (0.5 mm), using, for example, Vibrational Sieve systems.

The size of the powdered composite material can be defined by its d90. In some examples, the composite material has a d90 below 1 mm; at times, equal or below about 900 μm; at times, equal or below 800 μm; at times, equal or below 700 μm; at times, equal or below 600 μm; at times; equal or below 500 μm.

In some examples of the presently disclosed subject matter, the thermoplastic material with which the presently disclosed particulate matter is preferably used is one including a mixture of at least heterogenous organic matter.

In some examples of the presently disclosed subject matter, the thermoplastic material with which the presently disclosed particulate matter is preferably used is one including a mixture of heterogenous synthetic plastic material.

In some examples of the presently disclosed subject matter, the thermoplastic material with which the presently disclosed particulate matter is preferably used is one including a mixture of heterogenous organic matter and heterogenous synthetic plastic material.

In some examples of the presently disclosed subject matter, the thermoplastic material with which the presently disclosed particulate matter is preferably used is one including also inorganic matter.

In some examples of the presently disclosed subject matter, the thermoplastic material with which the presently disclosed particulate matter is preferably used is one including a mixture of heterogenous organic matter, heterogenous synthetic plastic material and inorganic matter.

In some examples of the presently disclosed subject matter, when the particulate matter is directly mixed with the thermoplastic material (e.g. without apriori preparing a masterbatch) to form a final blend, the amount of the particulate matter in the total amount of the combination of particulate matter and thermoplastic material can be as low as between 0.01 wt % and 5 wt %; at times, between 0.01 wt % and 3 wt %; at times, between 0.5 wt % and 4 wt %; at times about 0.5 wt % and 1 wt %; at times, about 0.8 wt % (±0.5 wt %).

The resulting product of mixing the particulate matter and the thermoplastic material, e.g. from which the article of manufacture is produced, can be characterized by its physical properties, as determined from a sample that has been subjected to injection molding.

In some examples, the injection molding sample can be characterized by its tensile Young's modulus determined according to ISO 527 using specimen type 1A/ASTM D638, test speed of 50 mm/min.

In the following Examples, an injection molding sample was tested for physical properties. To this end, an injection molding was prepared from a combination of a of heterogenous organic matter, heterogenous plastic matter and optionally inorganic matter of a type described in any one of WO22/113068, WO2010/082202, WO2012/007949 and WO23/031911 (referred to above), including up to about 4 wt % of the presently disclosed particulate matter and about 80 wt % PP (i.e., a final amount of the particulate matter being about 0.8 wt %).

Based on the exemplified injection molding sample, the presently disclosed subject matter also provides any injection molding sample comprising a combination of (i) an amount of about 20 wt % of a thermoplastic material comprising a heterogenous organic matter, heterogenous plastic matter and optionally inorganic matter, e.g. of a type described in WO22/113068 and WO23/031911 and including at least 0.1 wt % of the presently disclosed particulate matter (e.g. about 4 wt %) and (ii) about 80 wt % PP.

In some examples of the presently disclosed subject matter, the injection molding sample defined above is characterized by a tensile Young's modulus of at least 1000 MPa.

In some examples of the presently disclosed subject matter, the injection molding sample defined above is characterized by its total elongation at break, also known as total elongation, according to ISO-527-2.

In some examples of the presently disclosed subject matter, the injection molding sample defined above is characterized by a total elongation of at least 14%.

In some examples of the presently disclosed subject matter, the injection molding sample can be characterized by its Notched Izod Impact Strength as measured using ISO 180 ASTM D256 Hammer 1J, 23° C. Notched (Izod Impact Strength, edgewise notched specimens).

In some examples of the presently disclosed subject matter, the injection molding sample is characterized by a Notched Izod Impact Strength of at least 7 kJ/m².

In some examples of the presently disclosed subject matter, the injection molding sample can be characterized Flexural Modulus as determined using ASTM D790/ISO 178 method, with test speed of 5 mm/min.

In some examples of the presently disclosed subject matter, the injection molding sample is characterized by a Flexural Modulus of at least 1000 MPa.

As noted above, the presently disclosed particulate matter can be used in producing articles of manufacture, e.g. for reducing unpleasant odor released from the article when prepared from the same materials, absent the particulate matter.

Thus, in accordance with another (third) aspect of the presently disclosed subject matter, there is also provided an article of manufacture comprising a homogenous blend of (i) particulate matter comprising insoluble, non-magnetic, inorganic oxide particles, having, on each particle's surface, a plurality of, covalently grafted, ricinoleate compounds, and (ii) at least one thermoplastic material.

The particulate matter forming part of the article of manufacture has the same meanings as provided with respect to the particulate matter of the first aspect of the present disclosure, and thus, any definitions provided with respect to the first aspect of the presently disclosed subject matter, are also applicable to the particulate matter according to the method of the second aspect of the presently disclosed subject matter and to the article of manufacture according to the third aspect of the presently disclosed subject matter.

The article of manufacture comprises the presently disclosed subject matter particulate matter, essentially homogeneously mixed within thermoplastic material, as defined herein. It is noted that all definitions and meanings provided with respect to the thermoplastic material in connection with the method according to the presently disclosed second aspect, are also applicable to the article of manufacture of the third aspect disclosed herein.

Of particular interest are articles of manufacture that comprise the particulate matter and composite materials having thermoplastic properties (behavior), the composite material comprising a combination of heterogenous non-synthetic organic matter, heterogenous synthetic (plastic) matter and optionally inorganic matter.

Further, of particular interest are articles of manufacture that comprise the particulate matter and composite matter of the type disclosed in any one of WO22/113068, WO2010/082202 and WO23/031911, and WO2012/007949, the content of which is incorporated by reference, in their entirety.

Further, of particular interest are articles of manufacture that comprise the particulate matter and composite matter of the type disclosed in WO22/113068.

Articles of manufacture comprising composite material (as the thermoplastic material) as described in any one of WO22/113068, WO2010/082202 and WO23/031911 can be characterized by an amount of up to 40% plastic matter, and organic (non-synthetic) matter in an amount ranging from 10% and 90%.

Further, such composite material can be characterized by their heterogeneity, which is associated with the fact that they are derived form municipal waste.

Other characteristics of the composite material that can constitute the thermoplastic material in the presently disclosed article of manufacture are described hereinabove.

In some examples of the presently disclosed subject matter, the thermoplastic material comprises one or more synthetic polymers.

In some examples of the presently disclosed subject matter, the one or more synthetic polymers in the thermoplastic material comprises or is a polyolefin.

In some examples of the presently disclosed subject matter, the thermoplastic material comprises heterogeneous synthetic polymers.

In some examples of the presently disclosed subject matter, the thermoplastic material comprises at least one synthetic polymer selected from the group consisting of Acrylic, Acrylonitrile butadiene styrene (ABS), Polyamide, Polylactic acid (PLA), Polybenzimidazole, Polycarbonate, Polyether sulfone, Polyoxymethylene, Polyether ether ketone, Polyetherimide, Polyethylene, Polyphenylene oxide, Polyphenylene sulfide, Polypropylene, Polystyrene, Polyvinyl chloride, Polyvinylidene fluoride, Polytetrafluoroethylene (Teflon) and combinations of same

In some examples of the presently disclosed subject matter, the thermoplastic material comprises a combination of non-synthetic organic matter, synthetic polymers and optionally inorganic matter, the amount of synthetic polymers being up to 40 wt %.

In some examples of the presently disclosed subject matter, the thermoplastic material comprises recycled material having thermoplastic properties.

In some examples of the presently disclosed subject matter, the recycled material is a composite material comprising heterogenous non-plastic organic matter.

In some examples of the presently disclosed subject matter, the article of manufacture comprises an essentially homogenous dispersion of said particulate matter within the thermoplastic material.

The presently disclosed subject matter also provides, in accordance with its fourth aspect, a method of producing an article of manufacture, the method comprising processing a blend of (i) particulate matter comprising insoluble, non-magnetic, inorganic oxide particles, having, on each particle's surface, a plurality of, covalently grafted, ricinoleate compounds and (ii) thermoplastic material.

In some examples of the presently disclosed method of producing the article of manufacture, the processing comprises subjecting the blend to at least one stage of mixing under shear forces.

In some examples of the presently disclosed method of producing the article of manufacture, the processing comprises subjecting the blend to at least one stage of extrusion, molding, injection molding, compression molding and/or blown film of said blend.

It is to be appreciated that the particular matter used in the method according to the fourth aspect of the present disclosure is the same particulate matter of the first, second and third aspects of the presently disclosed subject matter. Therefore, all definitions provided with respect to the particulate matter with respect to the first, second and third aspects of the presently disclosed subject matter are applicable to the method according to the fourth aspect of the presently disclosed subject matter.

It is further to be appreciated that the thermoplastic material in the method according to the fourth aspect of the present disclosure is the same thermoplastic material defined hereinabove, inter alia, in connection with the third aspect of the presently disclosed subject matter. Therefore, all definitions provided hereinabove with respect to the thermoplastic material are applicable to the method according to the fourth aspect of the presently disclosed subject matter.

The article of manufacture is produced mainly from thermoplastic material. Thus, the method of its production typically utilizes methods, devices and system used in the plastic industry where thermoplastic material is employed.

In some examples of the presently disclosed subject matter, the method comprises mixing an amount of up to 0 wt %, at times, up to 9 wt %; at times, up to 8 wt %; at times, up to 7 wt %; of the particulate matter and the rest being composite material.

In some examples of the presently disclosed subject matter, the method comprises mixing between about 1 wt % and 10 wt %; at times, between about 2 wt % and 8 wt %; at times, between 2 wt % and 7 wt %; at times between 4 wt % and 6 wt %; at times about 5 wt % of the particulate matter and the rest being composite material.

It is to be appreciated that in the disclosed method, the particulate matter can be blended with a combination of virgin plastic and recycled waste.

In some examples of the presently disclosed subject matter, the thermoplastic material used for producing the article of manufacture comprises a blend of virgin thermoplastic polymer(s) such as polyolefins (e.g. polypropylene, polyethylene) and/or other synthetic polymers.

In some examples of the presently disclosed subject matter, the thermoplastic material used for producing the article of manufacture comprises a blend of virgin thermoplastic polymer(s) and recycled plastics.

In some examples of the presently disclosed subject matter, the thermoplastic material used for producing the article of manufacture comprises a blend of virgin thermoplastic polymer(s) with a composite material obtained from municipal waste.

In some examples of the presently disclosed subject matter, the thermoplastic material used for producing the article of manufacture comprises a blend of virgin thermoplastic polymer(s) with recycled waste comprising heterogenous synthetic plastics and heterogenous organic matter. e.g. organic matter typically found in municipal waste.

In some examples of the presently disclosed subject matter, the thermoplastic material used for producing the article of manufacture comprises a blend a blend of virgin thermoplastic polymer(s) with a composite material comprising up to about 40 wt % recycled plastic and between about 10 wt % and 90 wt % non-synthetic organic waste, and optionally up to 15 wt % inorganic matter.

In some examples of the presently disclosed subject matter, the thermoplastic material used for producing the article of manufacture comprises a blend of virgin thermoplastic polymer(s) with composite material of a type described in any one of WO22/113068, WO2010/082202, WO2012/007949 and WO23/031911.

In some examples of the presently disclosed subject matter, the thermoplastic material used for producing the article of manufacture comprises a blend of virgin thermoplastic polymer(s) with composite material of a type described in any one of WO22/113068, WO2010/082202, WO2012/007949 and WO23/031911, the amount of the virgin polymer being between about 50 wt % to 90 wt %; at times, between 60 wt % and 80 wt % and the amount of the composite material being between up to 70 wt %; at times, up to 60 wt %, at times, up to 50 wt %; at times, up to 40 wt %; at times up to 30 wt %, with the amount of the particulate matter being up to about 5 wt %.

In the following Examples, an injection molding sample was tested for physical properties. To this end, an injection molding was prepared from a combination of a of heterogenous organic matter, heterogenous plastic matter and optionally inorganic matter of a type described in any one of WO22/113068, WO2010/082202, WO2012/007949 and WO23/031911 (referred to above), including up to about 4 wt % of the presently disclosed particulate matter and about 80 wt % PP (i.e., a final amount of the particulate matter being about 0.8 wt %).

Based on the exemplified injection molding sample, the presently disclosed subject matter also provides any injection molding sample comprising a combination of (i) an amount of about 20 wt % of a thermoplastic material comprising a heterogenous organic matter, heterogenous plastic matter and optionally inorganic matter, e.g. of a type described in WO22/113068 and WO23/031911 and including at least 0.1 wt % of the presently disclosed particulate matter (e.g. about 4 wt %) and (ii) about 80 wt % PP.

The particulate matter should not be limited to specific uses and impact can be employed in any situation where at least odor and/or volatiles of the material with which the particulate matter is blended, needs to be at least partially scavenged/reduced. As noted above, this can be utilized in the plastic industry, in the recycling industry, in the waste management industry etc. As used herein, the forms “a”, “an” and “the” include singular as well as plural references unless the context clearly dictates otherwise. For example, the term “particle” includes one or more particles having the recited characteristics.

Further, as used herein, the term “comprising” is intended to mean that the particulate matter includes the recited components, i.e. the inorganic particles and ricinoleate compounds, but not excluding other elements. The term “consisting essentially of” is used to define particulate matter which include the recited elements, namely, inorganic particles and ricinoleate compounds but exclude other elements that may have an essential significance on the properties of the particulate matter. “Consisting of” shall thus mean excluding more than trace elements of other elements. Embodiments defined by each of these transition terms are within the scope of this invention.

Further, as used herein, the term “substantially” is intended to mean a certain quality or characteristic which is correct or attributable either at all times or to a large extent or degree. The term “substantially unsorted waste” shall thus mean waste material (including solids) that is either unsorted, e.g. obtained as is, i.e. in the form it is received at a waste management facility or at a waste dump or waste material from which some (and not more than 20 wt %) components are optionally selectively removed before processing.

Further, as used herein, the term the term “essentially intact particles” is intended to mean particles that are detectable or recognizable using appropriate detection methods. In this context the particles can be completely intact. However, the term does not only refer to completely intact particles, but it comprise also fragments of the particles. In this context, in particular fragments are encompassed which can be recognised by the person skilled in the art as fragments or parts of the particles to be detected.

Further, all numerical values, e.g. the amounts or ranges of the components constituting the particulate matter or defining the method of its production or use disclosed herein are approximations which are varied (+) or (−) by up to 20%, at times by up to 10% of from the stated values. It is to be understood, even if not always explicitly stated that all numerical designations are preceded by the term “about”. For example, the term “about 10%” should be understood as encompassing the range of 9% to 11%.

The invention will now be exemplified in the following description of experiments that were caried out in accordance with the invention. It is to be understood that these examples are intended to be in the nature of illustration rather than of limitation. Obviously, many modifications and variations of these examples are possible in light of the above teaching. It is therefore, to be understood that within the scope of the appended claims, the invention may be practiced otherwise, in a myriad of possible ways, than as specifically described hereinbelow.

### DESCRIPTION OF SOME NON-LIMITING EXAMPLES

### Materials

Benzoyl peroxide was purchased from Sigma Aldrich (Rehovot, Israel);
PY-88 (Zn ricinoleate) was purchased from Evonik (Eltra Chemicals/Helion), in powder form having dimensions of about 6-8 mm.
Zinc Ricinoleate was purchased from Acme Synthetic Chemicals (India) (designated herein below Acme ricinoleate)
ZeoFlair 100, Aerosil 200 and Aerosil 300 were purchased from Evonik (Rheinfelden, Germany).
TiO₂ particles: TiO₂(RC-919)—Plastlist, Average particle size, 0.26˜0.30 μm specific gravity, 3.9 gr/cm³
Ethanol (AR) was purchased from Simada Ltd.
Epoxidized Soybean Oil (ESBO) was purchased from Nantong Harma International (James Peles Ltd).
Castor Oil was purchased from Gustav Heess (ZIV Chemicals Ltd).
Capilene ST75 (Polypropylene) was purchased from Carmel Olefins Ltd.

### Example 1: Zinc Ricinoleate for Plastic Odor Scavenging (Reference Material)

To evaluate the efficiency of the presently disclosed subject matter, the effect of odor scavenging in recycled waste, was compared to that of Zn ricinoleate (i.e. without nanometric silica). The efficiency of Zn ricinoleate from two different sources (i.e., PY-88 (Evonik) and Activated ricinoleate (Acme Synthetic Chemicals) was used as a reference.

Blending with composite material and plastic material—The Zn ricinoleate beads was blended with powdered composite material prepared as described in WO22113068, the content of which is incorporated herein by reference or with virgin polypropylene (Capilene ST 75) in the ratio: 20% Composite material (powder), 79% virgin polypropylene, 1% Zn ricinoleate.

The composite material was downsized to a particle size of about 500 micron (see downsizing according to WO22113068).

Each of the blends were extruded in a Twin screw extruder, Coperion, ZSK 18MegaLab at 170-180° C., 250 RPM, 4 kg/h. The extruded material was then injected into an injection molding machine at 180° C. After remaining in the went for an hour the specimens were placed in an open glass jar and kept in the open air for 24 hours.

The resulting specimens were then analyzed.

Sensory test—Resulting specimens were submitted to a sensory test by trained smelling panel. The tests were performed after 24 hours. The odor intensity of the specimens was graded between 0 and 5 compared to the reference sample (a sample without an odor scavenger), wherein 0 is odorless and 5 is strong odor.

Table 1 provides the sensory test results.

TABLE 1
Smell scoring results

| Sample Name | Reference | PY-88 | Acme Ricinoleate |
|---|---|---|---|
| Average score of smelling | 5 | 2.5 | 4 |
| tests after 24 H | | | |

The above results show that the Zn ricinoleate per se, namely, without an inorganic carrier such as silica, was effective in reducing the unpleasant odor intensity of the injected molded products. However, the resulting products were non-homogenous and inconsistent in their odor reduction. Specifically, repeated attempts to reproduce the above sensory effect on the same product composition were inconsistent and thus it was determined that the incorporation of zinc ricinoleate as is, is unsuitable for industrial scale production of products comprising composite material comprising heterogenous waste, such as that disclosed in any one of WO22113068, WO2010/082202, and WO23031911.

Without being bound by theory, it was assumed that the lack of consistency in the effect received when mixing commercial beads of Zn ricinoleate (as is, with no carrier material) with the powdered composite material which is different in size resulted in a non-homogenous blend. Attempts to reduce the size of Zn ricinoleate resulted in its melting (and thus impossible), and in other words, was impossible or very difficult.

Thus, it was envisaged that there is a need to differently present the ricinoleate into the process of blending with other thermoplastic materials. It was further envisaged that this can be achieved by physically associating the ricinoleate onto a carrier having dimensions (or other properties) that are compatible with the powder with which the ricinoleate-carrier is to be homogenized/blended.

The physical association between ricinoleate and a carrier was performed by two procedures, solid state (Example 2A) and liquid phase (Example 2B).

### Example 2A: Solid-State Ricinoleate Grafted Particles

Sample preparation—Solid inorganic particles (ZeoFlair 100 (7 μm) or Aerosil 200 (12 nm)) were added to an ethanolic solution of Zn ricinoleate (starting material). Following the addition of benzoyl peroxide (0.05 g/l), the mixture was exposed to ultrasonic treatment at 4° C. with a 25% amplitude, which was provided in 30 min pulses using Sonics Vibra Cell VCX-750 ultrasonic liquid processor (Sonics & Materials Inc., Newtown, CT, USA).

Next, the reaction was allowed to proceed for 24 hours at room temperature. The resulting Zn ricinoleate grafted particles were separated by filtration (for ZeoFlair 100 and Aerosil 200) or centrifugation at ˜7000 RPM for 10 min (for Aerosil 300). For removal of impurities (e.g. non-bound ricinoleate), the samples were washed with ethanol and dried in a vacuum furnace at 60° C. overnight.

Table 2 provides details of the different ricinoleate grafted nanoparticles

TABLE 2
Zn Ricinoleate grafting - solid-state formulations

| | | Particle | Zn | Benzoyl | |
|---|---|---|---|---|---|
| | Particle | concentration | ricinoleate | peroxide | Ricinoleate |
| | type* | (g/L) | (g/L) | (g/L) | type |
| KRS-2 | Zeoflair | 10 | 3.33 | 0.05 | PY-88 |
| KRS-3 | Zeoflair | 3.33 | 10 | 0.05 | PY-88 |
| KRS-4 | Zeoflair | 10 | 10 | 0.05 | PY-88 |
| KRS-5 | Aerosil 200 | 10 | 3.33 | 0.05 | PY-88 |
| KRS-6 | Aerosil 200 | 10 | 10 | 0.05 | PY-88 |
| KRS-7 | Aerosil 200 | 10 | 20 | 0.05 | PY-88 |
| KRS-8 | Aerosil 200 | 10 | 30 | 0.05 | PY-88 |
| KRS-9 | Aerosil 200 | 10 | 5 | 0.05 | Acme |
| | | | | | ricinoleate |
| KRS-10 | Aerosil 200 | 10 | 10 | 0.05 | Acme |
| | | | | | ricinoleate |
| KRS-11 | Aerosil 300 | 10 | 10 | 0.05 | Acme |
| | | | | | ricinoleate |
| KRS-12 | Aerosil 300 | 10 | 20 | 0.05 | PY-88 |
| KRS--13 | Aerosil 300 | 30 | 10 | 0.05 | PY-88 |

Blending with Recycled Waste

The resulting ricinoleate grafted powders (having essentially the size range of the carrier, i.e. no significant increase in size due to the grafting) were blended with virgin polypropylene (Capilene ST 75) and with powder of the composite material prepared from substantially unsorted municipal waste as described in WO22113068 (particle size of about 500 nm) the content of which is incorporated herein by reference. The blending was at the ratio: 20% composite material/79%, virgin polypropylene/1% Zn ricinoleate grafted particulate matter.

The resulting homogenous blend was extruded compounded in a Twin-screw extruder, Coperion, ZSK 18MegaLab at 170-180° C., 350 RPM, 4 kg/h.

The extruded compound was injected molded by injection molding machine. After remaining in the vent for an hour the specimen was placed in an open glass jar and kept in the open air for 24 hours.

The extruded materials were submitted to a sensory test according to the protocol described hereinabove. It is noted that the reference was as provided in Table 1 above, with an average score of smell test after 24 hours of 5.

The results of the smelling test are provided in Table 3.

TABLE 3
Smell scoring results

| Sample | Average score of smelling tests after 24 H |
|---|---|
| KRS-2 | 4 |
| KRS-3 | 3 |
| KRS-4 | 4 |
| KRS-5 | 3 |
| KRS-6 | 2 |
| KRS-7 | 3.5 |
| KRS-8 | 3 |
| KRS-9 | 3.5 |
| KRS-10 | 4 |
| KRS-11 | 3.5 |
| KRS-12 | 3 |
| KRS-13 | 4 |

The above results show that all types of particulate matter, where the ricinoleate was covalently grafted on the carrier particle, were effective in reducing intensity of the odor as compared to the reference. In addition, the numerous examples, all being effective in reducing odor intensity as compared to the reference, was indicative of the homogeneity of the extruded product and supported the underlying assumption that for a repetitive and stable process, there is a need for the ricinoleate particles to be carried on particles, as the powder, and that the carrier powder has a size (or other properties) compatible with the powder with which is mixed (the heterogenous composite material).

Table 3 further shows that best result was obtained with the formulation KRS-6, when the carrier was Aerosil 200.

### Example 2B: Liquid Formulation

Solid inorganic particles: SiO₂ with average particle size 12 nm (Aerosil 200) or TiO₂ with a particle size average particle size of 0.26˜0.30 μm were added to a solution of ricinoleate compound (i.e., either PY88 or castor oil) in epoxidized soybean oil (ESBO) as the organic solvent, with ratio's described in Table 4.

Recrystallized benzoyl peroxide (BP) was added (final concentration 0.005 wt. %) and was all components were pre-mixed using mechanical stirrer for 20 min. The mixture was then exposed to the ultrasonic treatment with an amplitude of 25%, provided in two 15 min. pulses using Sonics Vibra Cell VCX-1500 Watt ultrasonic processor (Sonics & Materials Inc., Newtown, CT, USA).

Following the ultrasonic treatment, the reaction was allowed to proceed for 30 min., at room temperature.

TABLE 4A
Ricinoleate grafting - liquid formulations.

| | | | | Ricin- | | |
|---|---|---|---|---|---|---|
| | | Particle | | oleate | Benzoyl | Ricin- |
| | Particle | concentration | ESBO | compound | peroxide | oleate |
| Sample | type | (g/L) | (L) | (g/L) | (g/L) | type |
| KRS-14 | Aerosil 200 | 10 | 1000 | 10 | 0.05 | PY88 |
| KRS-15 | Aerosil 300 | 20 | 1000 | 10 | 0.05 | PY88 |
| KRS-16 | Aerosil 300 | 10 | 1000 | 20 | 0.05 | PY88 |
| KRS-17 | Aerosil 300 | 10 | 1000 | 30 | 0.05 | PY88 |
| KRS-18 | Aerosil 200 | 20 | 1000 | 10 | 0.05 | PY88 |
| KRS-19 | Aerosil 200 | 10 | 1000 | 20 | 0.05 | PY88 |
| KRS-20 | Aerosil 200 | 10 | 1000 | 10 | 0.05 | Castor oil |
| KRS-21 | Aerosil 200 | 20 | 1000 | 20 | 0.05 | Castor oil |
| KRS-22 | Aerosil 200 | 30 | 1000 | 30 | 0.05 | Castor oil |
| KRS-23 | Aerosil 200 | 45 | 1000 | 45 | 0.05 | Castor oil |
| KRS-24 | Aerosil 200 | 50 | 1000 | 50 | 0.05 | Castor oil |
| KRS-25 | Aerosil 200 | 45 | 1000 | 45 | — | Castor oil |
| KRS-26 | Aerosil 200 | 45 | 1000 | 90 | 0.05 | Castor oil |
| KRS-27 | Aerosil 200 | 90 | 1000 | 45 | 0.05 | Castor oil |
| KRS-28 | Aerosil 200 | 45 | 1000 | 45 | 0.05 | Castor oil |
| KRS-29 | TiO₂ | 45 | 1000 | 45 | 0.05 | Castor oil |

*Benzoyl peroxide (BP) without recrystallization

The resulting liquid formulations were extruded together with virgin polypropylene and the composite material prepared by extrusion as described in WO22113068 (composite material particle size of up to about 500 μm) the content of which is incorporated herein by reference. The ratio between the components was as described above, namely, 20% composite material/79%, virgin polypropylene/1% Zn ricinoleate grafted particles. The conditions of extrusion are also as described above.

The extruded materials were submitted to a sensory test according to the protocol described hereinabove.

The results of the smelling test are provided in Table 5.

TABLE 5
Smell scoring results

| Sample | Average score of smelling tests after 24 H |
|---|---|
| KRS-14 | 3 |
| KRS-15 | 3.5 |
| KRS-16 | 3 |
| KRS-17 | 2.5 |
| KRS-18 | 3 |
| KRS-19 | 4 |
| KRS-20 | 3 |
| KRS-21 | 3 |
| KRS-22 | 2.5 |
| KRS-23 | 1 |
| KRS-24 | 3 |
| KRS-25 | 4 |
| KRS-26 | 3 |
| KRS-27 | 3.5 |
| KRS-28 | 3 |

Table 5 shows that all formulations of the particulate matter, irrespective of the concentrations of the components used for their production (Table 4) were effective in reducing odor intensity (below the reference of 5). The fact that all formulations were effective, is indicative that when using carrier particles grafted with the ricinoleate (the disclosed particulate matter) their use in reducing odor is reproducible and essentially consistent/repeatable.

Notably, also with the wet formulations, the best result was obtained with silica carriers, and specifically with formulation KRS-23.

### Example 3: Spectroscopic Characterization

KRS-23 and KRS-29 particles were selected for further analysis by Attenuated Total Reflection Fourier-Transform Infrared Spectroscopy (ATR-FTIR).

Sample preparation—The ricinoleate grafted particles were separated from the organic media by filtration. For removal of any unbound ricinoleate, the samples were washed with 99% ethanol. Finally, the samples were dried in a vacuum furnace at 60° C. overnight.

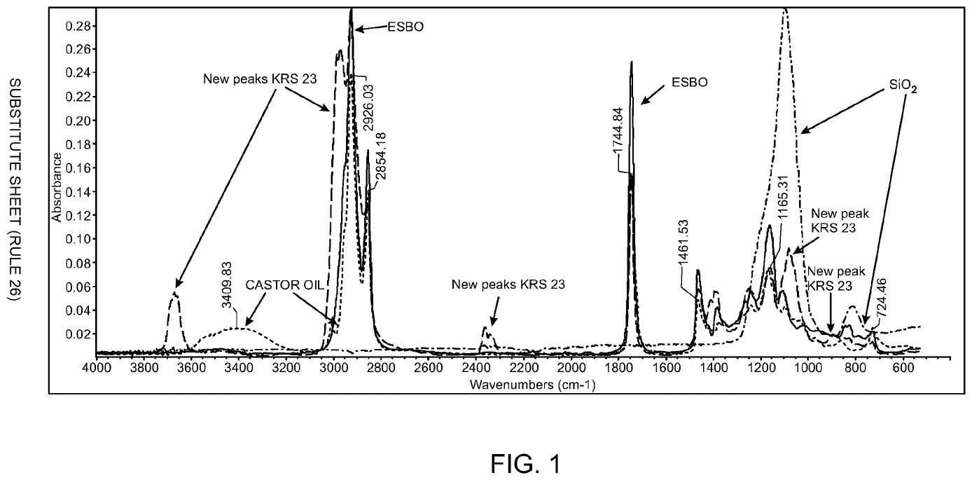

The observed changes in the FTIR spectra of castor oil provide evidence for ricinoleate covalent binding to the surfaces of both silica (i.e., KRS-23) and TiO₂ (i.e., KRS-29). This binding process is characterized by distinct alterations in peak positions, peak disappearances, and the emergence of new peaks (FIG. 1-FIG. 3; Table 6).

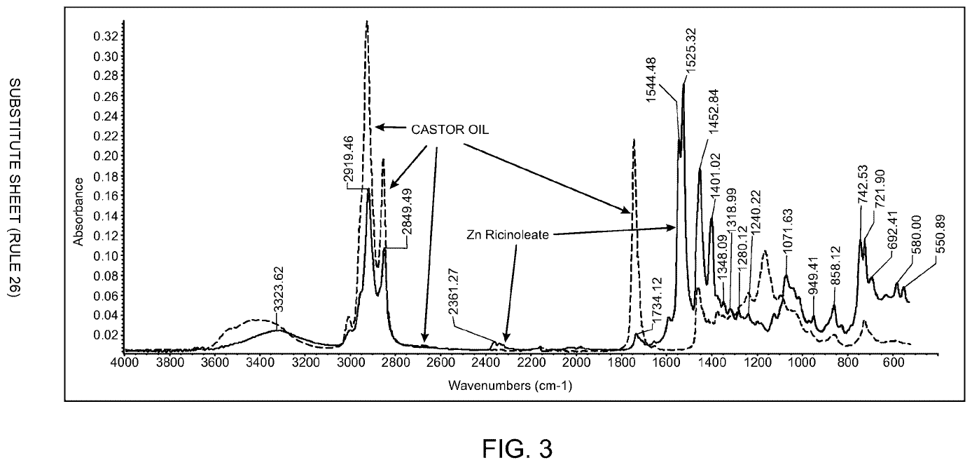

In the case of silica as the carrier particle (see FIG. 1), the shift of the castor oil peak from 3409 cm⁻¹ to 3672 cm−1 (O—H) suggests presence of Si—OH groups, which are absent in the pristine silica spectrum. Further, the appearance of a new peak at 2361 cm⁻¹ (FIG. 1) corresponding to C—O stretching which is absent in castor oil (FIG. 3) is attributed to the covalent binding of ricinoleate species to silica surface. Furthermore, this interaction leads to modifications in other regions of the spectrum as well. Notably, new peaks at 2976 cm⁻¹ and 2985 cm⁻¹ emerge in the aliphatic hydrocarbon region due to altered stretches and asymmetric stretches induced by the covalent bond formation.

Notably, peaks at 1078 cm⁻¹ and 894 cm are attributed to Si bonding with the ester group through the alkoxy end (—C(O)—O—Si), with the frequency shift being influenced by the number of alkoxy groups involved.

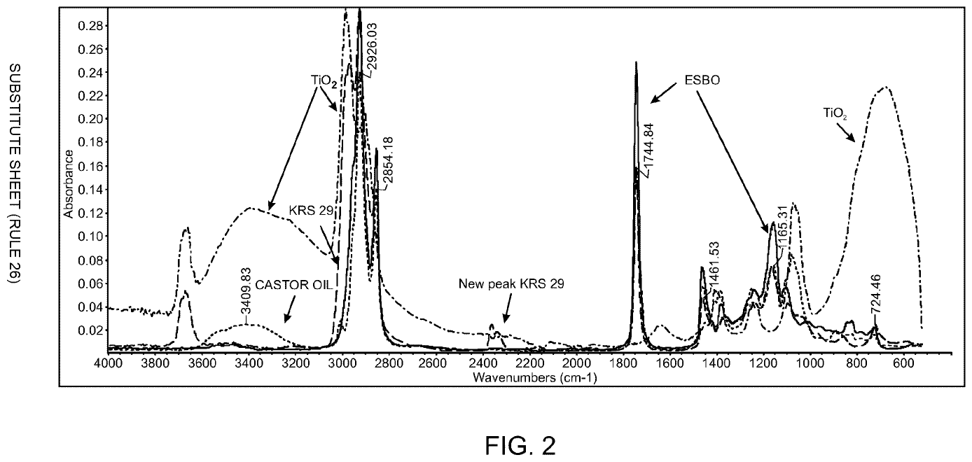

Similarly, in the case of TiO₂ particles, the FTIR spectra reveal a disappearance of most TiO₂-related peaks (FIG. 2; Table 6), corroborating a binding event. As seen in Table 6, a new peak arises at 2360 cm⁻¹, signifying changes in C—O stretches comparable to the changes observable in the case of silica binding.

In essence, the FTIR analysis substantiates the covalent attachment of ricinoleate species from the castor oil to the surfaces of both silica and TiO₂, accompanied by distinctive shifts, appearances of new peaks, and modifications in existing bands, all indicative of the covalent bond formation between the ricinoleate species and particle surface.

TABLE 6
Summary of ATR-FTIR analysis

| | | | |
|---|---|---|---|
| New | | Disappeared | |
| peaks (cm⁻¹) | Attribution | Peaks (cm⁻¹) | Attribution |

KRS-23

| | | | |
|---|---|---|---|
| 3672 | —O—H | 3409 | —O—H |
| 2985 | —Si—O—H | | |
| 2976 | —CH₂ | | |
| 2985 | —CH2 | | |
| 2361 | —C—O | | |
| 1078 | —Si—O—C═O ester | | |
| 894 | —Si—O—C═O ester | | |

KRS-29

| | | | |
|---|---|---|---|
| 2360 | —C—O | 3381 | Ti—O |
| | | 1638 | Ti—O |
| | | 3409 | —O—H |
| | | 679 | Ti—O |

### Example 4: Thermochemical Characterization

The thermochemical characterization of KRS-23 was performed according to the procedure described in Suckeveriene, R. Y., et al. (2009), Polymer composites 30 (4): 422-428.

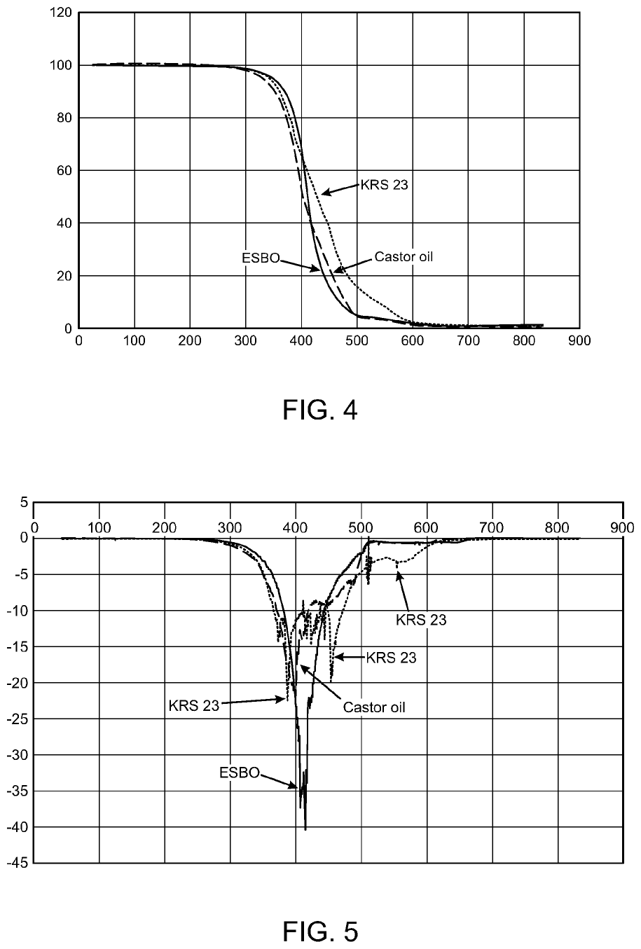

The TGA graph (FIG. 4) reveals a noticeable shift towards higher temperatures in thermal decomposition profile of KRS-23 in comparison with thermal decomposition profile of free (unbound) castor oil. This change in thermal behavior confirms the covalent grafting of ricinoleate species.

Further, the DTG curve of free (unbound) castor oil in FIG. 5 exhibits single transition at ca. 400′C. On the other hand, the DTG curve of KRS-23 exhibited an additional transition characterized by a minor peak at ca. 565° C. which represents thermal decomposition of covalently bound ricinoleate.

Overall, the outcome of thermochemical characterization aligns with ATR-FTIR measurements, serving as further evidence supporting the formation of a covalent bond between ricinoleate species and particle surface.

Notably, it was found that approximately 11% of ricinoleate by weight is associated with the surface.

### Example 5: Mechanical Characterization

Sample preparation—Samples for tensile tests were prepared as follows: the sample material (Table 6A) was extruded at 170-180° C. and 350 rpm using a ZSK 18 lab extruder, to obtain a homogenous material. The extruded material was ground by the lab granulator and the granulated material was injection molded by the Haitian 120 t at 170-180° C., to make test specimens. The test specimens were conditioned for at least 48 hours at 23±2° C.

Tensile tests—tensile properties were determined according to ISO 527 using specimen type 1A/ASTM D638, test speed of 50 mm/min.

Elongation test—according to ISO-527-2.

Impact Izod (notched)—Izod Impact was measured using ISO 180 ASTM D256 Hammer 1J, 23° C. Notched (Izod Impact Strength, edgewise notched specimens).

Flexural tests—The test was conducted using ASTM D790/ISO 178 method, with test speed of 5 mm/min.

TABLE 7A
Composition of the samples used in physical tests

| Material | Reference | KRS6/KRS-23# |
|---|---|---|
| Composite material* (%) | 20.0 | 20.0 |
| KRS-6/KRS-23 (%)# | 0 | 1 |
| PP (Capilene ST75) (%) | 80.0 | 79 |

*prepared as described in WO22113068, downsized to 500 micron
#either KRS-6 or KRS-23 was used

TABLE 7B
Mechanical properties

| Mechanical Property | Reference | KRS-6 | KRS-23 |
|---|---|---|---|
| Tensile Young's Modulus (MPa) | 1190 | 1140 | 1060 |
| Total elongation (%) | 14.2 | 15.2 | 19.7 |
| Izod Impact Strength (kJ/m²) | 7.8 | 8.4 | 9.5 |
| Flexural modulus (MPa) | 1010 | 1070 | 1080 |

Overall, the addition of KRS-23 led to a greater improvement of mechanical properties than the addition of KRS-6, although also KRS-6 improved the properties as compared to the reference. An upward trend from the reference up to KRS-23 was observed in both Izod Impact Strength and Total elongation. Furthermore, the addition of KRS-23 provided higher stiffness as reflected in higher Young's and Flexural moduli.

1. Particulate matter comprising insoluble, non-magnetic, inorganic oxide particles, having, on each particle's surface, a plurality of, ricinoleate compounds directly covalently grafted to the surface of said particles, wherein said particulate matter is characterized by at least one of:
(a) having sizes in the nanometric and/or micrometric ranges;
(b) having an ATR-FTIR peak indicative of said covalent graft of ricinoleate compounds onto said insoluble particle, at least at wavenumber within the range of 800 and 1100 cm⁻¹; or
(c) said insoluble particles, without said ricinoleate compounds, having a surface area of at least 50 m²/g,
or any combination thereof.

2.-5. (canceled)

6. The particulate matter of claim 1, wherein said insoluble particles are selected from the group consisting of silica, zeolite, titania, alumina, clay, and mixtures thereof.

7. (canceled)

8. The particulate matter of claim 1, wherein said insoluble particles are not zinc oxide, magnetite and/or carbon-carbon containing particles.

9. The particulate matter of claim 1, wherein said plurality of ricinoleate compounds are selected from the group consisting of ricinoleic acid, ricinolein and mixtures thereof.

10.-12. (canceled)

13. A method of producing particulate matter, the method comprising
i) providing a suspension comprising insoluble inorganic oxide particles and a source of ricinoleate compounds;
ii) subjecting said suspension to at least a sonication process; and
iii) optionally separating the particulate matter.

14. The method of claim 13, wherein said inorganic oxide particles are characterized by at least one of:
(a) being non-magnetic particles;
(b) prior to sonication, having a surface area of at least 50 m²/g;
(c) prior to sonication, having an average size in the nanometric to micrometric range; or
(d) being selected from the group consisting of silica, zeolite alumina, titania, and clay, or any combination thereof.

15.-18. (canceled)

19. The method of claim 13, wherein said insoluble particles are not zinc oxide, magnetite and/or carbon-carbon containing particles.

20. The method of claim 13, wherein said source of ricinoleate compounds is selected from the group consisting of castor oil, ricinoleic acid, ricinolein and zinc ricinoleate and/or wherein said suspension is a suspension in an organic medium.

21. (canceled)

22. The method of claim 20, wherein said organic medium comprises an oil.

23. The method of claim 22, wherein said organic medium comprises an oil selected from the group consisting of epoxidized soybean oil (ESBO), tall oil, castor oil, linseed oil, and palm oil.

24. (canceled)

25. The method of claim 13, wherein said suspension comprises a radical initiator.

26. The method of claim 25, wherein said radical initiator is selected from the group consisting of benzoyl peroxide, di-tert-butyl peroxide, methyl ethyl ketone peroxide and ammonium persulfate.

27. (canceled)

28. The method of claim 13, wherein said sonication process comprises ultrasonication, wherein said ultrasonication is characterized by at least one of:
(a) ultrasonic power within a range of between about 400 W and about 25 kW;
(b) ultrasonic frequency within a range of between about 15 kHz and about 200 kHz; or
(c) time sufficient to cause covalent grafting of a plurality of said ricinoleic acid compounds directly onto at least the surface of said inorganic oxide particles;
or any combination thereof.

29.-31. (canceled)

32. An article of manufacture comprising a homogenous blend of (i) particulate matter comprising insoluble, non-magnetic, inorganic oxide particles, having, on each particle's surface, a plurality of, covalently grafted, ricinoleate compounds, and (ii) at least one thermoplastic material.

33. The article of manufacture of claim 32, wherein said article is characterized by at least one of:
(a) said particulate matter being as defined in claim 1; or
(b) said thermoplastic material comprising one or more synthetic polymers, wherein said one or more synthetic polymers comprises or is a polyolefin,
or both thereof.

34.-35. (canceled)

36. The article of manufacture of claim 33, wherein thermoplastic material comprises heterogeneous synthetic polymers.

37. (canceled)

38. The article of manufacture of claim 32, wherein said thermoplastic material comprises a combination of non-synthetic organic matter, synthetic polymers and optionally inorganic matter, the amount of synthetic polymers being up to 40 wt %.

39. The article of manufacture of claim 32, wherein said thermoplastic material comprises recycled material having thermoplastic properties.

40. The article of manufacture of claim 39, wherein said recycled material is a composite material comprising heterogenous non-plastic organic matter.

41. The article of manufacture of claim 32, comprising an essentially homogenous dispersion of said particulate matter within the thermoplastic material.

42.-44. (canceled)
